(19) United States
(12) Patent Application Publication
(10) Pub. No.: US 2004/0092233 A1
(43) Pub. Date: May 13, 2004

(54) Variable rate closed loop power control for wireless communication systems

(76) Inventor: Ashok N. Rudrapatna, Basking Ridge, NJ (US)

Correspondence Address: MORGAN & FINNEGAN, L.L.P., 345 Park Avenue, New York, NY, 10154-0053, US

(21) Appl. No.: 10/290,815

(22) Filed: Nov. 8, 2002

(51) Int. Cl. H04B 1/00; H04B 7/00; H04Q 7/20

(52) U.S. Cl. 455/69; 455/70; 455/522

(57) ABSTRACT

A system and method for variable rate closed loop power control in a wireless communications system, such as a CDMA spectrum system. A base station receives the reverse link transmission from a wireless terminal unit (WTU) and determines the signal quality of the reverse link, measures the signal-to-interference ratio (SIR) or other signal quality indicators of the received signal to determine any power adjustments required for the uplink transmission power. The base station also processes the uplink transmission signal to determine whether the rate of transmitting power control data to the WTU should be changed from the current rate. If so, the base station either (1) sends a power control rate change command to the WTU via the downlink, and sends subsequent power control commands at the newly determined rate, or (2) sends subsequent power control commands at the newly determined rate without sending a power control rate change command. The WTU determines the power control rate, either by extracting the power control rate change command or by performing blind rate detection, and recovers subsequent power control commands at the new rate. Closed loop power control for controlling the power of downlink transmissions from the base station to the WTU may be implemented in a similar manner to provide variable rate (bandwidth) closed loop power control channels.

### TECHNICAL FIELD

The present invention relates generally to wireless communication systems, and more particularly to controlling the channel associated with power control in a wireless communication system such as a code division multiple access (CDMA) communication system.

### BACKGROUND OF THE INVENTION

Transmitter power control is important in wireless communications systems, such as cellular, PCS (Personal Communications Services), 3G (third-generation wireless), wireless LAN, etc., such systems being based on various underlying technologies or standards, such as CDMA (e.g., IS-95B, W-CDMA, cdma2000, UMTS (Universal Mobile Telecommunication System), TDMA (i.e., time division multiple access; e.g., GSM, IS-136), IEEE 802.11a/b, Bluetooth, etc. Since CDMA (as well as other spread spectrum systems) is well-suited for illustrating not only the importance of such power control, but also the system design, resources, and/or tradeoffs that may be associated with providing for effective power control, for clarity the ensuing background art description discusses power control primarily in the context of CDMA systems.

In a CDMA system, signals sent by different wireless terminal units (WTUs; e.g., users' mobile terminals) occupy the same portion of the frequency spectrum (i.e., frequency band) at the same time, and similarly, signals sent to different wireless terminal units (e.g., from a base station) simultaneously occupy another frequency band. That is, CDMA channels overlap in both the time and frequency domains. Communications to and from different wireless terminal units are discriminated (channelized) by assigning a unique spreading code to each communication channel on the forward link (from a base station to the WTU's) and reverse link (from the WTU's to the base station). More specifically, each channel's baseband information signal (e.g., a 9.6 KB/s vocoder output signal) is encoded by a high rate code sequence (e.g., a Walsh (forward link) or psuedo-random noise (PN) (reverse link) code of 1.2288 Mchips/s), thus spreading the spectrum of the baseband data signal over the entire forward or reverse link transmission frequency band (e.g., 1.25 MHz). Since the unique spreading codes are orthogonal (or psuedo-orthogonal) to each other, to recover the desired signal from among those signals simultaneously occupying the same frequency band, a CDMA station (e.g., a base station or a wireless terminal unit) receives the signals in the frequency band, and uses the unique code sequence assigned to the desired channel to despread the received signal and extract and discriminate the desired channel.

While the simultaneous sharing of the same frequency spectrum (band) by a plurality of user terminals provides for, and can increase the bandwidth efficiency of, a multiple access communications system, it also makes effective power control of transmitted signals extremely important in order to provide quality communication and high system capacity. That is, all users' signals in the same frequency band interfere with one another inasmuch as a station's (e.g., a base station's or a user's wireless terminal unit's) receiving channel detects user signals other than the desired communication signal as noise. In the reverse link, since the signal received by a base station from a wireless terminal will be stronger when the wireless terminal is closer to the base station, the base station's reception of a distant terminal's signal may be dominated by a closer terminal if the transmission powers are not appropriately controlled. This problem is referred to as the “near-far effect”, and it may be controlled by transmitter power control to achieve a constant received mean power for each terminal. Power control is also important in improving CDMA system performance by compensating channel fading (e.g., Rayleigh fading, which typically varies rapidly). Power control is also employed in the forward link to mitigate against channel fades and also to minimize system interference.

Simply stated, effective power control (PC) is essential to gain maximum benefit from spread spectrum CDMA systems. Typical systems make use of both open loop and closed loop PC. Closed loop PC (both inner and outer loop) requires the use of PC feedback control channels or sub-channels (which are also hereinbelow referred to as “channels”) to deliver PC bits from the signal receiver (Rx) to the signal transmitter (Tx) of a two-way wireless link to control the transmitted signal to an appropriate level. These techniques are implemented in existing (e.g., IS95 standard) and proposed (e.g., cdma2000, W-CDMA, UTRA, etc.) systems. For example, IS-95 includes both open loop PC and closed loop PC for the uplink, and slow power PC for the downlink, and such power control techniques are fully described in any of the versions of the IS-95 standard adopted by the Telecommunications Institute of America (TIA): e.g., TIA/EIA-95B, Baseline Version, Jul. 31, 1997; TIA/EIA-95A, 1995; and TIA/EIA-95, 1993, each entitled “Wireless terminal unit-Base Station Compatibility Standard for Dual-Mode Wideband Spread-Spectrum Cellular System.” Likewise, fast PC for both forward and reverse link are employed in the emerging 3G standards, both cdma2000 and UMTS systems. Even non-spread spectrum systems (e.g., TDMA and FDMA) are investigating PC as a technique to minimize system interference and thereby improve system capacity and performance.

These PC channels, however, consume valuable air interface resources (e.g., bandwidth) in each direction. For instance, the cdma2000 standard uses 800 bps per user, while the W-CDMA uses 1500 bps per user in each direction. Air interface bandwidth for each channel is limited, and there is an increasing need for additional bandwidth to handle traffic data. This need is particularly enhanced, for example, by the desire to develop further wireless data communications applications (e.g., wireless internet access) that demand high data rates as well as high signal quality (e.g., low bit error rate (BER)).

It may be appreciated, therefore, that there remains a need for further advancements and improvements in providing high quality, high bandwidth wireless communications, and particularly in increasing the available bandwidth that is devoted to communicating user information (e.g., voice and/or user data) while also providing the power control necessary for high integrity wireless communication.

### SUMMARY OF THE INVENTION

The present invention provides such advancements and overcomes the above mentioned problems and other limitations of the background and prior art, by providing a system and method for variable rate closed loop power control in a wireless communication system.

In accordance, with an aspect of the present invention, a wireless apparatus (device or station, e.g., a base station or a wireless terminal unit) receives a wireless transmission signal from a second wireless apparatus (e.g., a wireless terminal unit or a base station) and determines any power adjustments required or recommended for the transmission power of the wireless transmission signal from the second wireless apparatus. The wireless apparatus also processes the wireless transmission signal to determine whether the rate of transmitting power control (PC) data to the second apparatus should be changed from the current rate. If so, the system dynamically adapts to the change in PC bit rate either implicitly by the wireless apparatus changing the data rate and the second wireless apparatus independently detecting the PC rate change through blind rate detection or explicitly by the wireless apparatus sending a power control rate change command to the second wireless apparatus via the wireless communication link. Subseqent power control commands are sent from wireless apparatus to the second wireless apparatus at the newly determined rate. The second wireless apparatus recovers (extracts) the power control rate change either implicitly or explicitly and processes it such that the second wireless apparatus will recover subsequent power control commands at the new rate. In accordance with another aspect of the present invention, closed loop power control for controlling the power of transmissions from the wireless apparatus to the second wireless apparatus may be implemented in a similar manner to provide variable rate (bandwidth) closed loop power control channels. As noted, the wireless apparatus may be implemented as a base station, and the second wireless apparatus may be implemented as a wireless terminal unit (e.g., a mobile telephone handset) in a cellular communications system.

### BRIEF DESCRIPTION OF THE DRAWINGS

Additional aspects, features, and advantages of the invention will be understood and will become more readily apparent when the invention is considered in the light of the following description made in conjunction with the accompanying drawings, wherein:

FIG. 1 shows an illustrative communication network in which the present invention may be practiced;

FIG. 2 depicts a functional block diagram of an illustrative CDMA base station that may be used to implement an embodiment of the present invention; and

FIG. 3 depicts a functional block diagram of an illustrative CDMA wireless terminal unit that may be used to implement an embodiment of the present invention.

### DETAILED DESCRIPTION OF THE INVENTION

For clarity of exposition, the ensuing description of an illustrative embodiment of the present invention is directed to a wireless CDMA communications system (e.g., cellular or PCS), such as an IS-95 compliant system; however, those skilled in the art understand that variable rate closed loop power control in accordance with the present invention is not limited to a wireless CDMA system, but may be implemented in any of myriad spread spectrum or non-spread spectrum (e.g, TDMA) wireless communications systems.

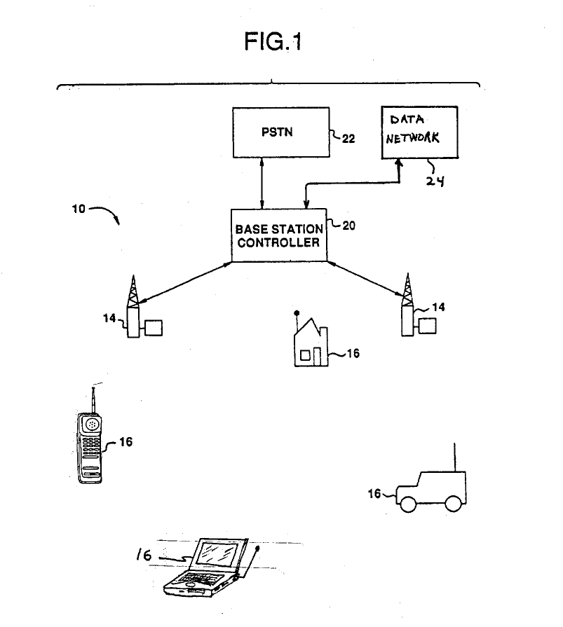

FIG. 1 shows an illustrative communication network 10 in which the present invention may be practiced. Communication network 10 generally comprises one or more base stations 14, each of which may communicate wirelessly with a plurality of wireless terminal units 16 according to spread spectrum techniques, such as any of the versions of the IS-95 direct spread CDMA (DS-CDMA) standards approved by the Telecommunications Industry Association (TIA). As pictorially depicted, wireless terminal units 16 may be implemented as any of a variety of mobile (slow moving, fast moving, or stationary but capable of moving) or fixed (i.e., always stationary) devices including, for example, a cellular telephone, a vehicle mounted phone, a notebook computer, or a personal digital assistant (PDA). Each wireless terminal unit (WTU) 16 typically communicates with one or more (while in soft handoff) base stations 14 that provides the strongest communication signals. The base stations 14 also communicate with a base station controller 20, which coordinates communications among base stations 14. Communication network 10 may also be connected to a public switched telephone network (PSTN) 22 and/or a data network 24, wherein the base station controller 20 also coordinates communications between the base stations 14 and these networks. Each base station 14 may communicate with base station controller 20 over a wireless link or a wireline. A wireline is particularly applicable when a base station 14 is in close proximity to the base station controller 20. As is well known, communication system 10 may be implemented as a cellular system in which each cell includes one or more base stations, and WTUs 16 may roam among cells, and/or as a terrestial/non-cellular system (e.g., local loop). Additionally, those skilled in the art understand that communication system 10 may be implemented as a public and/or private (e.g., premises based, such as for a residence or campus) network.

Base station controller 20 provides all of the controlling and signaling associated with establishing and maintaining all of the wireless communications between the WTUs 16, the base stations 14, and the base station controller 20; for example, controller 20 may handle handover related functions of a mobile WTU between base stations of different cells (or different sectors within a cell). As noted, base station controller 20 provides an interface between wireless communication system 10 and the PSTN 22 as well as data network 24, which interface includes multiplexing and demultiplexing of the communication signals that enter and leave the system 10 via the base station controller 20. It may be appreciated that in the schematic depiction of FIG. 1, base station controller 20 may be viewed as subsuming the functionality of what is often denoted a mobile switching center (MSC), which typically may be implemented as located separately from a base station controller (e.g., connected between PSTN 22 and one or more base station controllers). Additionally, in various implementations, functions of the base station controller 20 may be combined with a base station 14. Such system architecture distinctions are not necessary for understanding the present invention, however, and thus FIG. 1 is schematically set forth at a high level for clarity of exposition.

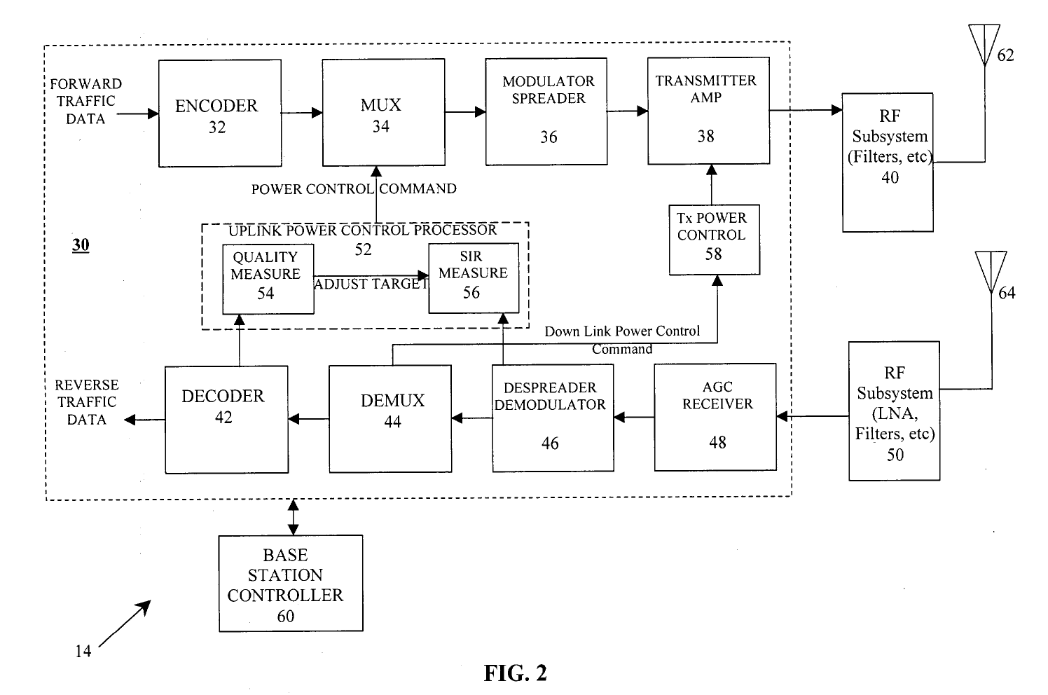

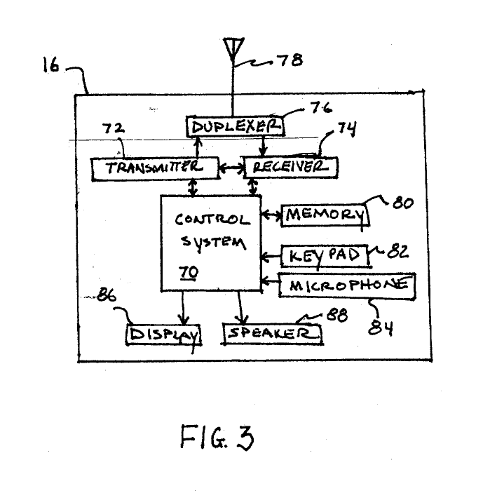

An embodiment of the present invention is now described in connection with a functional block diagram description of base station 14 and WTU 16, schematically depicted in FIG. 2 and FIG. 3, respectively. It is noted, that these figures schematically depict functional block diagrams of a base station (showing one channel) and a WTU to illustrate the signal transmission, processing, and operational flow that occurs in an implementation of variable (adaptive) rate closed loop power control, in accordance with an embodiment of the present invention. It is understood that the functional blocks represent functions (e.g., processing) that may be provided through the use of shared or dedicated hardware, such as, for example, one or more processors (e.g., programmed microcontroller, special or general purpose digital signal processors (DSPs), finite state machines implemented with combinational and/or sequential logic, etc.), analog signal processing circuitry (e.g., analog filters, power amplifiers, etc.), and the mapping of functions to actual system (hardware and/or software) design and chip architecture may be implemented in various ways. It is also further noted that for clarity of exposition these functional block diagrams do not necessarily set forth all elements and functions that may be included in base station 14 and WTU 16. For example, some other functions that may be provided in such equipment may include interleaving, scrambling, variable traffic data rate selection, etc.

FIG. 2 depicts a functional block diagram of an illustrative CDMA base station 14 that may be used to implement an embodiment of the present invention. Base station 14 includes a base station controller 60, RF subsystems 40 (for transmitter) and 50 (for receiver), and antennae 62 and 64.

In the transmitter section, forward traffic data (e.g., voice from a vocoder, non-voice data, etc.) is fed on a block-wise basis into an encoder 32, which adds forward error correction capabilities using, for example, convolutional or turbo encoding. Into the signal output from encoder 32, multiplexer 34 inserts a power control command provided by uplink power control processor 52. As will be further understood below, in accordance with an embodiment of the present invention, this power control command includes not only a power adjust command to control the transmission power of WTU 16, but could also be a power control rate command for informing the WTU 16 of the rate of subsequent power control commands. Modulator/spreader 36 modulates an RF carrier with the signal from multiplexer 34, and also spreads this modulated signal with a spreading code. Transmission amplifier 38 amplifies the spread/modulated signal into an amplified signal in response to a gain determined by transmission power controller 58. The amplified signal is sent to RF circuit 40 which drives antenna 62 such that the signal is transmitted as a radio signal on the forward channel (downlink) to be received by WTUs 16.

Radio signals transmitted by WTUs 16 on the reverse (uplink) channel are received through an antenna 64 and a RF circuit 50. More specifically, the receiver section of transceiver 30 includes an automatic gain control receiver 48, a despreader/demodulator 46, a demultiplexer 44, and a decoder 42. Uplink power control processor 52, which includes quality measurer 54 and signal-to-interference (SIR) measurer 56, may also be considered as being part of the receiver section, although it is also in communication with the transmitter section. Automatic gain control receiver 48 amplifies the signal received from RF subsystem 50 into an amplified signal with a prescribed amplitude, which signal is provided to despreader/demodulator 46 for despreading (using the spreading code) and demodulating (using a local oscillator at the RF carrier frequency) to provide a resulting digital signal to demultiplexer 44. Demultiplexer 44 extracts down link power control information from this digital signal and provides the rest of the resulting digital signal sequence to decoder 42, which decodes this resulting digital signal to produce an output signal corresponding to the reverse traffic data transmitted by the WTU 16.

More specifically, demultiplexer 44 extracts power control information (e.g., messages/commands) transmitted by WTU 16 to inform or command the base station. For example, in accordance with the downlink power control loop specified by the IS-95 standard, this power control information may represent the downlink signal quality (e.g., frame error rate, FER) measured by WTU 16. Alternatively, (e.g., for fast closed loop power control), this power control information may directly command the base station to adjust the transmission power (either up or down in specified steps).

As will be further understood below, in accordance with an embodiment of the present invention in which variable rate power control is implemented for the downlink (e.g., in addition to, or exclusive of, uplink variable rate power control), the power control information extracted by demultiplexer 44 may include power control commands not only for specifying or determining power adjustments (referred to herein as power control (PC) adjust commands), but also for specifying the rate of transmission of power control commands (referred to herein as power control rate commands) by WTU 16. That is, a power control command (i.e., a power control rate command) sent by WTU 16 may inform the base station that subsequent power control commands from WTU 16 will occur at a specified rate. The power control rate command may indicate the rate in various ways; for example, as a single step increment or decrement along a predetermined rate scale (e.g., increment or decrement rate to next rate), as a variable amount increment or decrement along a predetermined rate scale (e.g., increment or decrement rate by a certain number of steps), or as an index to any rate on a predetermined rate scale (e.g., set rate to a rate pointed to by an index number).

Accordingly, demultiplexer 44 and transmission power controller 58 cooperate to extract and process power control commands at a variable rate/delay-time (e.g., after a specified number of frames) specified (via the power control information extracted by demultiplexer 44) by the WTU 16 that is in communication with transceiver 30. Specifically, demultiplexer 44 extracts power control commands at a rate/delay time specified by the most recent power control rate command received from WTU 16. In the event that the extracted power control command is a power control adjust command, demultiplexer 44 provides this information to transmitter power controller 58, which uses it to determine the gain for transmission amplifier 38. In the event that the extracted power control command is a power control rate command, demultiplexer 44 stores this rate internally for use in acquiring subsequent power control commands at the appropriate delay times, and transmitter power controller 58 determines the gain for transmission amplifier 38 in accordance with its control algorithm (e.g., if no new power control adjust command is received, then maintain same gain or, in an alternative algorithm consonant with IS-95 slow power control, then periodically decrease gain).

It is noted that in an alternative embodiment, WTU 16 may vary the PC data rate to the base station without using a PC adjust command/message to explicitly inform the base station of the rate change, and the base station may detect this rate change using blind rate detection (e.g., blind rate detection circuitry functionally incorporated with demultiplexer 44, which extracts power control information accordingly).

As shown in FIG. 2, decoder 42 and despreader/demodulator 46 are coupled to uplink power command controller 52, which provides the power control command to multiplexer 34 of the transmitter section of transceiver 30. As described above, in accordance with an embodiment of the present invention, this power control command includes not only a power adjust command to control the transmission power of WTU 16, but also a power control rate command for informing the WTU 16 of the rate of subsequent power control commands. Uplink power command controller 52 determines the desired power adjustment and the desired power control rate based on the signal-to-interference ratio (SIR) of the signal, although other signal information (e.g., received signal strength, received bit energy to noise density (Eb/Io)) may be used instead or in conjunction therewith. More specifically, as indicated by its connection to despreader/demodulator 46, SIR measurer 56 measures the SIR present in the received, despread signal, and compares it to a target SIR value generated by quality measurer 54 to determine whether the transmission power of WTU 16 should be increased or decreased. It is noted that quality measurer 54 determines the SIR target value by measuring the signal quality (e.g., bit error rate) based on forward error correction (e.g., convolutional coding) implemented by WTU 16 and used during decoding by decoder 42. Those skilled in the art recognize that this adjustable SIR target represents an outer loop to compensate for the variability in the SIR required to provide a given bit error rate.

Uplink power command controller 52 may determine the rate for communicating power control commands based on the rate of change of the power adjustment determined by power command controller 52 itself. For example, in general terms, if the rate of change of the power adjustments required (e.g., number of adjustments per number of frames, calculated over a certain number of successive frames) is less (greater) than a first (second) fraction of the rate that power control commands are sent to the WTU 16, then the rate of transmitting power control commands may be reduced (increased). As explained below, the algorithm for determining the power control command rate may be based on various parameters or variables, (such as vehicle or channel doppler), and for a given set of parameters or variables, the specific alogorithm may be implemented in various ways.

Uplink power command controller 52 is cooperative with multiplexer 34 to insert power control commands (adjustments and rate commands) at a rate equal to the most recent rate inserted and communicated to the WTU 16. In accordance with an embodiment of the present invention, once uplink power command controller 52 determines that the rate should be changed, if it has also determined that a power adjustment is necessary, it will first effect transmission of the power adjust command, and then effect transmission of the power control rate command in the subsequent available time for multiplexing power control commands. If it determines that no power adjustment is necessary and that the rate should be changed (increased or decreased), it sends the power control rate command at the first available time for multiplexing power commands. Additionally, if it determines that no change should be made to the transmission rate of power control commands, then it sends the currently determined power adjust command at the first available time for multiplexing power commands corresponding to the established (i.e., most recently transmitted) power control command rate. It is also possible both power levels and the rate may change, in which case both will be signaled. It is noted that, upon initial establishment of the channel, a predetermined rate (e.g. the maximum rate) is initially used by both transceiver 30 and WTU 16 to transmit and receive power control commands until the traffic communication channel is established and uplink power command controller 52 determines that the rate should be changed.

In accordance with an alternative embodiment of the present invention, variable rate uplink closed loop PC need not employ PC adjust commands. That is, uplink power command controller 52 may vary the PC data rate to WTU 16 without using a PC adjust command/message to explicitly inform WTU 16 of the rate change, and WTU 16 may detect this rate change using blind rate detection (e.g., blind rate detection circuitry functionally incorporated into the receiver of WTU 16).

Referring now to FIG. 3, there is shown an illustrative high level functional block diagram of WTU 16, which may implement an embodiment of the present invention, and which may be in communication with base station 14 (e.g., to transceiver 30). WTU (device) 16 includes a duplexer 76 that selectively couples a transmitter 72 and a receiver 74 to an antenna 78 to respectively send an uplink signal containing reverse data to base station 14 (e.g., to transceiver 30) and receive a downlink signal containing forward data from base station 14 (e.g., from transceiver 30). WTU 16 is controlled by control system 70 which preferably includes a microprocessor or a microcontroller unit, as well as any additional analog or digital circuitry for controlling and/or interfacing with each of the elements (e.g., microphone, transceivers, speaker) coupled thereto. Control system 70 is coupled to a memory 80 which may store programs and/or data executed or processed to control wireless operation, as well as information that is entered by a user, the distributor, the communication services provider, or the manufacturer. A user communicates with control system 82 via keypad (or keyboard) 82. Control system 70 may communicate information (e.g., associated with operating the wireless device, or corresponding to forward traffic data received by the wireless device) to the user via display 86 and/or via speaker 88. Audio (e.g, voice) information used for generating reverse traffic (voice) data for transmission on the uplink channel from the WTU 16 to base station 14 may be received via microphone 84.

Transmitter 72 includes any encoding, multiplexing, modulating, spreading, and amplification circuitry, as well as any other signal processing circuitry required for communicating a reverse data signal to base station 14 in accordance with CDMA. Similarly, receiver 74 includes any automatic-gain-control-receiving, despreading, demodulating, dumultiplexing, and decoding circuitry, as well as any other signal processing circuitry required for receiving a downlink (forward) channel signal from CDMA base station 14 and providing the forward traffic data contained therein. Additionally, as depicted, transmitter 72 and receiver 74 are coupled to allow communication of information therebetween. More specifically, those skilled in the art will understand that the design and operation of transmitter 72 and receiver 74 may correspond to, as well as mirror, that of a single transceiver (e.g., transceiver 30) of base station 14, and thus these details are not shown for clarity of exposition. It is noted, however, that this correspondence or mirroring does not mean that transmitter 72 and receiver 74 necessarily have all the same or equivalent structures and functions as base station transceiver 30, but merely indicates that transmitter 72 and receiver 74 includes circuitry and/or functions to provide or support communications (e.g., including power control commands and rate change messages) with transceiver 30.

More particularly, as described above, in accordance with an embodiment of the present invention, transceiver 30 may receive a power control command from wireless device 16, which command is used to control the downlink power for transceiver 30. Accordingly, WTU 16 includes circuitry or functionality to provide this power control command to transceiver 30, and thus may include circuitry for measuring the received downlink SIR and/or quality, generating a power control command based on this measurement, and inserting the power control command into the reverse data signal. That is, WTU 16 may include circuitry analogous to downlink power command control circuit 52 (e.g., containing circuitry corresponding to quality measurer 54 and/or SIR measurer 56) and multiplexer 34 of transceiver 30. Note, however, that the downlink signal characterization by WTU 16 need not be implemented in the same manner as power command control circuit 52 characterizes the uplink signal characteristics. For instance, in an alternative implementation, such as wherein the control of transceiver 30's downlink power is based on slow power control according to IS-95, receiver 74 may employ an uplink power command controller that determines the power adjust command according to a signal quality measurement without performing an SIR measurement. In such an implementation, for example, a frame error ratio (FER) may be measured in accordance with a decoder decoding the convolutional or turbo encoding (which provides error correction) performed by transceiver 30 on the forward traffic data. Thus, it may be appreciated that it is in this manner that WTU 16 may “mirror” or correspond to transceiver 30; WTU 16 includes appropriate circuitry to receive, process, and/or generate signals transmitted on the downlink channel by transceiver 30 as well as signals received on the uplink channel by transceiver 30, which does not require that WTU 16 have the same functionality or the same circuitry as transceiver 30.

As described above, in accordance with an embodiment of the present invention, the types of power control commands that may be sent from the base station to the WTU include a power adjust command that instructs the WTU 16 that is in communication with transceiver 70 to adjust its transmission (uplink) power, and a power control rate command that instructs the WTU 16 as to a change in the rate of subsequent power adjust commands from base station 14. Receiver 74 includes circuitry (e.g., a demultiplexer, analagous to demultiplexer 44) for extracting the power control commands at the rate specified by the most recent power adjust command it extracted, as well as circuitry to appropriately process the extracted power control commands (e.g., circuitry embodied in its demultiplexer to decode/recognize the type of power control command, control the gain of its transmission power based on the power adjust command, and control the demultiplexing timing according to the received power adjust command). In an alternative embodiment in which power control rate commands are not used to explicitly communicate rate changes, WTU 16 includes blind rate detection circuitry to dynamically extract the variable PC command rate.

Again, it may be appreciated that the circuitry and functionality of transmitter 72 and receiver 74 corresponds to or mirrors the transceiver to the extent necessary to allow for communication therebetween and for implementing any closed loop power control that is provided for the uplink channel and/or the downlink channel. For instance, if there is both uplink and downlink closed loop power control, the respective signals received at the base station and the WTU need not be characterized (e.g., SIR, signal strength, FER) with the same type of measurement (e.g., SIR, signal strength, FER, etc.), and thus base station transceiver will not have circuitry precisely corresponding to circuitry in the wireless transmitter and receiver. Similarly, if closed loop power control were implemented to control the uplink transmission power but closed loop power control were not implemented to control the downlink transmission power, then the base station transceiver will include circuitry for characterizing the received uplink signal, but WTU may not need to implement any corresponding circuitry to characterize the received downlink signal. Simply put, transceiver 30 need not have the same circuitry as transmitter 72 and receiver 74, but they may have complementary circuitry for handling the closed loop power control.

In view of the foregoing description of base station 14 and WTU 16, including their functional operation, it is understood that in accordance with an embodiment of the present invention, power control commands for closed loop downlink power control (i.e., commands transmitted by the WTU to control the downlink transmission power) and/or power control commands for closed loop uplink power control (i.e., commands transmitted by the base station to the WTU to control the uplink transmission power) may include not only power adjust commands (to command the receiving device to adjust its transmission power) but also power control rate commands (to explicitly inform the receiving device of the rate that power control commands will be transmitted by the sending device). It is also understood that alternative embodiments need not employ such power control rate commands for the uplink and/or downlink, but may instead employ blind rate detection to implement closed loop PC. It is thus understood that the present invention may be implemented to employ variable rate closed loop power control for the downlink transmission power or the uplink transmission power, or both.

For example, as described above in connection with FIGS. 2 and 3, closed loop power control for the uplink transmission power from a CDMA WTU to a CDMA base station may be implemented as follows. The base station receives the uplink transmission from a WTU and measures the signal-to-interference ratio (SIR) of the received signal to determine any power adjustments required for the uplink transmission power. In accordance with the present invention, the base station also processes the uplink transmission signal to determine whether the rate of transmitting power control data to the WTU should be changed from the current rate. If so, the base station either (1) sends a power control rate change command to the WTU via the downlink, and sends subsequent power control commands at the newly determined rate, or (2) sends subsequent power control commands at the newly determined rate without sending a power control rate change command. The WTU determines the power control rate, either by extracting the power control rate change command or by performing blind rate detection, and recovers subsequent power control commands at the new rate. As described above, closed loop power control for controlling the power of downlink transmissions from the base station to the WTU may be implemented in a similar manner to provide variable rate (bandwidth) closed loop power control channels.

In somewhat more general terms, regardless of whether variable rate closed loop power control is implemented for controlling the transmission power of wireless transmissions of a first device (e.g., a base station) to a second device (e.g., a WTU), or for controlling the transmission power of wireless communications of the second device to the first device, or for both of these wireless communications, the present invention may be implemented in accordance with the following illustrative embodiment, which is described from the perspective of closed loop power control of the transmission power of a signal transmitted from a first device (e.g., a WTU or base station) to a second device (e.g., a base station when the first device is a WTU, or a WTU when the first device is a base station) that is in communication with the first device via wireless communication channels.

Upon establishment of a wireless traffic communication channel, closed loop power control is initially exercised at a predetermined rate (e.g., fast power control) via the closed loop PC channel. The receiver of the second device monitors the transmissions received from the first device and determines the rate of change of power control required for providing a certain level (e.g., optimal) of performance or quality. If the second device's receiver detects that the required rate of change of power is slower (faster) than the current PC data rate, it either (1) sends to the first device a power control message (rate command) that explicitly informs the first device that the PC data rate is being reduced (increased), and sends subsequent power control command messages at the changed rate, or (2) sends subsequent power control command messages at the changed rate without sending a power control message that explicitly informs the first device of the rate change. The first device determines the rate for receiving PC data either by (1) receiving and the PC control message that explicitly indicates the rate and processing this message such that the first device's receiver will recover subsequent power control commands (e.g., power adjustment or rate change commands) at the rate indicated by the received message, or (2) by using blind rate detection. The PC rate change can be accomplished in stages, namely, changes between the peak PC rate and the lowest PC data rate can be accomplished in steps. Note that, even with zero PC data rates, open loop PC can still exist and operate without consuming air interface capacity. In this manner, the PC data rate is variable.

An algorithm for determining the PC rate may be implemented in various ways, including as a function (linear or non-linear, including average, weighted average, variance, discrete mapping, etc.) of one or more of the following parameters: Doppler of the mobile or the channel, frame error rate, average frame error rate (which, evidently, is a function of the frame error rate), the received signal strength, the signal-to-noise, the receiver velocity, or the PC command signal itself. Note that the receiver velocity may be determined, for example, by estimating from the pilot signal, or an appropriate transducer incorporated into the mobile unit and/or by geo-positioning location techniques. A simple control algorithm may invoke PC rate changes based on the minimum PC rate required for maintaining a certain average signal quality or SIR or maintaining the variance in the SIR below some threshold. Another illustrative simple control algorithm, for example, may change the PC rate based on the rate of change of the PC command signal. More specifically, by way of a simple example for clarity of exposition, if the average rate of change of the PC command is greater (less) than a first (second) threshold, then a PC rate command will be invoked to increment (decrement) the PC rate to the next rate in a predetermined rate scale. Alternatively, instead of only sequential increments/decrements along a predetermined rate scale, the PC rate may be commanded to change by an amount that depends on the average rate of change of the PC command signal.

In view of the foregoing description of illustrative and preferred embodiments of the present invention, various illustrative variations or modifications thereof, and various background art, it may be appreciated that the present invention has many features, advantages, and attendant advantages. For example, by implementing variable data rate power control channels in accordance with the present invention, overall communications system performance may be enhanced by saving valuable air interface capacity (bandwidth) which may be selectively apportioned for other purposes (e.g., transmitting user data). It may be appreciated that implementing such variable rate power control may be particularly advantageous for fast power control loops (e.g., the closed loop downlink power control in IS-2000 or W-CDMA systems compliant systems), since the average percentage of channel bandwidth devoted to the closed loop control may be significantly reduced compared to that when using a fixed bandwidth for closed loop power control.). More specifically, by way of example, the IS-2000 standard specifies that power control bits are transmitted on the downlink and uplink fundamental code channel every 1.25 msec (i.e. a 800 Hz transmission rate). This consumes 800 bps for every user. Adapting an IS-95/IS-2000 compliant system to implement the present invention with a maximum variable rate of 800 Hz would render the mean transmission rate for power control commands below this 800 bps maximum. In W-CDMA systems the actual PC data rates can be reduced from the current maximum of 1500 bps/user to less than that. The freed bandwidth could thus be used to communicate other information, such as user information (e.g., data), and/or even additional commands or messages necessary to implement additional features, or support additional users.

It is noted that although some of these features and advantages are set forth from the perspective of modifying a CDMA standard by dynamically varying the power control channel bandwidth below the rate specified by the standard, it is appreciated that variable rate power control may be more generally viewed as advantageously optimizing the bandwidth devoted to closed loop power control. Simply, the present invention may be advantageously implemented to use the minimum bandwidth necessary to achieve effective closed loop power control in a spread spectrum or CDMA system, or other wireless communications system. From another perspective, the present invention may be viewed as increasing the bandwidth as needed. In fact, the present invention, for example, may allow communication of power control commands at a rate higher than (as well as lower than) that specified by a CDMA standard (e.g., greater than 800 Hz, if this is deemed necessary (e.g., due to extremely rapid fading.

It is also noted that because effective power control is essential to providing a CDMA system, reducing power control data rates in CDMA systems is generally contrary to conventional design wisdom. Nevertheless, the present invention recognizes, for example, that that all mobile units do not necessarily require the same power control data rate to maintain high integrity CDMA communication, and thus the data rate (bandwidth) devoted to exchanging power control information between a base station and a WTU may be varied. For example, in an IS-95B/IS-2000 compliant system, fast moving WTUs may require an 800 bps PC data rate for good communication performance, whereas slow moving WTUs, or fixed terminals may not require the high PC data rate and communicate adequately at a lower PC data rate. It is further noted, however, that motion of the WTU is not the only variable that may affect the needed PC data rate, and is set forth by way of example for ease of explanation. It is understood that variable PC data rate may be implemented in accordance with the present invention regardless of the factors affecting the required PC data rate.

Although the above description provides many specificities, these enabling details should not be construed as limiting the scope of the invention, and it will be readily understood by those persons skilled in the art that the present invention is susceptible to many modifications, adaptations, and equivalent implementations without departing from this scope and without diminishing its attendant advantages. It is therefore intended that the present invention is not limited to the disclosed embodiments but should be defined in accordance with the claims which follow.

We claim:

1. A wireless communications apparatus, comprising:
a circuit that extracts power control information present at a variable rate in a wireless signal transmitted by a first wireless communications device; and
a power control circuit that generates as a function of said power control information a signal operative to establish a power level for a wireless transmission signal to said first wireless communications device.

2. The wireless communications apparatus according to claim 1, wherein said circuit extracts the variable rate power control information independent of information from said first wireless communications device explicitly specifying the variable rate of the power control information.

3. The wireless communications apparatus according to claim 2, wherein said circuit extracts the variable rate power control information based on blind rate detection.

4. The wireless communications apparatus according to claim 1, wherein said wireless signal transmitted by said first wireless communications device includes power control rate command information that is indicative of the rate of the variable rate power control information.

5. The wireless communications apparatus according to claim 4, wherein the power control rate command information is intermittently contained in said wireless signal transmitted by said first wireless communications device, and said circuit extracts the variable rate power control information according to the rate indicated by the preceding power control rate command information.

6. The wireless communications apparatus according to claim 1, wherein said wireless communications apparatus is a base station or a wireless terminal unit.

7. The wireless communications apparatus according to claim 1, wherein said wireless communications apparatus is a spread spectrum communications device, and wherein said wireless signal transmitted by said first wireless communications device is a spread spectrum signal.

8. The wireless communications apparatus according to claim 1, wherein the rate of the variable rate power control information is a function of a Doppler metric representing the motion of said wireless communications apparatus.

9. A wireless communications apparatus, comprising:
a power control circuit that generates power control information based on a quality metric for a wireless signal transmitted by a first wireless communications device; and
a circuit that determines a variable rate for transmitting the power control information via a first wireless signal to said first wireless communications device.

10. The wireless communication apparatus according to claim 9, wherein the wireless communication apparatus transmits the power control information to said first wireless communications device at the variable rate independent of the wireless communication apparatus transmitting information that explicitly indicates the variable rate of the power control information.

11. The wireless communications apparatus according to claim 9, wherein the first wireless signal transmitted by the wireless communications apparatus includes power control rate command information that is indicative of the variable rate for transmitting the power control information.

12. The wireless communications apparatus according to claim 9, wherein said wireless communications apparatus is a spread spectrum communications device, and wherein said wireless signal transmitted by said first wireless communications device is a spread spectrum signal.

13. The wireless communications apparatus according to claim 9, wherein the variable rate of the power control information is determined as a function of a Doppler metric representing the motion of said first wireless communications apparatus.

14. The wireless communications apparatus according to claim 9, wherein the variable rate is based on a signal-to-interference ratio of said wireless signal transmitted by said first wireless communications device.

15. A method for closed loop control of the power of a first wireless signal transmitted by a first wireless communications apparatus to a wireless communications apparatus, the method comprising:
said first wireless communications apparatus receiving a wireless signal from said wireless communications apparatus;
said first wireless communications apparatus extracting power control information present at a variable rate in the received wireless signal; and
said first wireless communications apparatus generating as a function of the power control information a signal operative to establish a power level for said first wireless signal.

16. The method according to claim 15, wherein said extracting comprises recovering from said wireless signal power control rate information that indicates a rate of transmission by said wireless communications apparatus of subsequent power control information.

17. The method according to claim 15, wherein said extracting comprises performing blind rate detection.

18. A method for closed loop control of the power of a first wireless signal transmitted by a first wireless communications apparatus to a wireless communications apparatus, the method comprising:
said wireless communications apparatus receiving the first wireless signal from said first wireless communications apparatus
said wireless communications apparatus generating power control information based on a quality metric for the received first wireless signal; and
said wireless communications apparatus determining a variable rate for transmitting the power control information via a wireless signal to said first wireless communications device.

19. The method according to claim 18, further comprising said wireless communications apparatus transmitting the power control information at the variable rate via the wireless signal, the wireless signal including power control rate information that indicates the variable rate of transmission by said wireless communications apparatus of subsequent power control information.

20. The method according to claim 18, further comprising said wireless communications apparatus transmitting the power control information at the variable rate via the wireless signal, the wireless signal not including information that explicitly indicates the variable rate of transmission by said wireless communications apparatus of power control information.
